(19) United States
(12) Patent Application Publication
(10) Pub. No.: US 2010/0298077 A1
(43) Pub. Date: Nov. 25, 2010

(54) RATCHET-TYPE TENSIONER

(75) Inventors: Manabu Hirayama, Osaka (JP); Takahiro Matsushita, Osaka (JP); Katsuya Nakakubo, Osaka (JP); Yuji Kurematsu, Osaka (JP); Osamu Yoshida, Osaka (JP); Shintarou Yoshimoto, Osaka (JP)

Correspondence Address: HOWSON & HOWSON LLP, 501 OFFICE CENTER DRIVE, SUITE 210, FORT WASHINGTON, PA, 19034, US

(73) Assignee: Tsubakimoto Chain Co., Osaka (JP)

(21) Appl. No.: 12/762,433

(22) Filed: Apr. 19, 2010

(30) Foreign Application Priority Data
May 20, 2009 (JP) 2009-121767

(51) Int. Cl. F16H 7/08

(52) U.S. Cl. 474/110

(57) ABSTRACT

In a ratchet-type tensioner, a rocking ratchet pawl is released from a rack of teeth on a tensioner plunger following engine start-up by a hydraulically operated pin slidable in a pin hole and caused to protrude therefrom by oil under pressure received directly from an external oil supply, or alternatively from the tensioner's high pressure oil chamber through a passage in the tensioner housing. Optionally, an orifice can be provided within the pin hole to control flow of oil when the supply is excessive and to avoid leakage when the supply is insufficient.

### CROSS REFERENCE TO RELATED APPLICATIONS

This application claims priority under Title 35, United States Code, §119 (a)-(d) based on Japanese Patent Application No. 2009-121767, filed May 20, 2009. The disclosure of Japanese Patent Application No. 2009-121767 is incorporated by reference in its entirety.

### FIELD OF THE INVENTION

The invention relates to a ratchet-type tensioner for applying tension to the timing chain which drives a camshaft, and optionally other components, of an engine.

### BACKGROUND OF THE INVENTION

It is known to apply tension to a timing chain by means of a tensioner having a plunger slidable in a plunger-accommodating hole in a tensioner housing. The plunger and housing cooperate to form an oil chamber, and the plunger is urged in a direction to exert tensioning force on the timing chain by a plunger-biasing spring and also by hydraulic pressure applied from an external pressure source to the oil in the oil chamber.

FIG. 9 shows a tensioner described in Japanese laid-open patent application No. Hei. 6-94089. The tensioner 500 is composed of a housing 501 having a cylindrical hole 510 with an open end 513, receiving a plunger 502 which is slidable in, and protrudes from, the hole. A ratchet mechanism 503, comprising a pivoted pawl 531 having teeth 531a that cooperate with rack teeth 525 on the plunger, restricts retraction of the plunger 502.

A mechanism 504 prevents protrusion of the plunger 502 when the plunger is in a retracted condition as shown. The protrusion-preventing mechanism 504 includes a chamber 540 formed in the housing 501 on an outer peripheral side of the oil chamber 510. The chamber 540 communicates with the oil chamber 510 through a passage 543 that extends in a direction perpendicular to the axial direction of hole 510. A piston 542, slidable in chamber 540, has a locking projection 542b that enters a hole 526 in the plunger 502. A biasing spring 544 urges piston 542 in a direction such that its locking projection 542b enters hole 526 of the plunger.

The piston has pressure-receiving surfaces 542a, and 542c on the end of projection 542b. These pressure-receiving surfaces receive hydraulic pressure from the oil chamber 510. When the pressure-receiving surfaces 542a and 542c receive hydraulic pressure from the oil chamber 510, the locking projection 542b retracts from hole 526 in the plunger, thereby releasing the plunger 502 so that the tensioner can begin to operate. During operation, oil in high pressure oil chamber 510 leaks out through a restricted clearance between the plunger and the inner wall of the plunger-accommodating hole in the housing, thereby exerting a damping action when a force is suddenly applied to the plunger by an increase in chain tension.

If the engine is inoperative for a long period of time, air can enter the oil chamber 510, and, as a result, the hydraulic pressure in the oil chamber 510, which is influenced by pulsations in the hydraulic pressure generated by an oil pump on starting of the engine, may be insufficient. If a large force is imparted to the plunger 502 by the chain, while air is present in chamber 510, the force is sustained only by the ratchet mechanism 503 and by the force of the plunger-biasing spring 522 without assistance by the damping action of the oil. Consequently, there is a risk that the large force will result in breakage of one or more of the teeth 531a of the pawl or breakage of one or more teeth on the rack formed on the outside of plunger 502.

Accordingly, the prior art tensioner 500 requires a tough plunger-biasing spring 522 to sustain backlash of the plunger 502, and, as a result, the size of the tensioner is increased.

### SUMMARY OF THE INVENTION

Accordingly, the invention aims at solving the above-described problems of the prior art by temporarily disabling the ratchet mechanism on engine start-up, and thereby preventing the ratchet mechanism from being broken during engine start-up when the engine has not been operated for a long period of time.

The ratchet-type tensioner according to the invention comprises a housing having a first oil supply passage for introducing oil under pressure into the housing, a plunger-accommodating hole in the housing, and a plunger slidable in the plunger-accommodating hole and protruding in a projecting direction outward from an opening of the hole for applying tension to a traveling chain.

The plunger has a hollow interior which, in cooperation with the plunger-accommodating hole, forms a high-pressure oil chamber that expands with sliding movement of the plunger in the projecting direction and contracts with sliding movement of the plunger in a retracting direction opposite to the projecting direction. The plunger has a longitudinally extending rack comprising a set of rack teeth formed on its exterior.

A plunger-biasing spring in the high-pressure oil chamber, biases the plunger in the projecting direction. A check valve, located at an end of the plunger-accommodating hole opposite from its opening, is arranged to deliver oil from the oil supply passage into the high pressure oil chamber and to block reverse flow of oil from the high-pressure oil chamber to the oil supply passage.

A ratchet pawl, rockably supported on the housing for rotation about a pawl axis, has a pawl tooth engageable with, and disengageable from, the rack on the plunger for blocking retracting movement of the plunger when engaged with said rack. A pawl-biasing spring urges the pawl to rotate in a direction about the pawl axis such that its pawl tooth comes into engagement with the rack.

As described so far, the features of the tensioner are conventional features. The tensioner according to the invention is characterized by a pin receiving hole formed in the housing, a pin slidable in the pin-receiving hole and protruding therefrom, the pin being in engagement with the pawl and arranged to rotate the pawl about its pawl axis in a direction such that the pawl tooth disengages from the rack when the pin moves in its protruding direction, and a second oil supplying passage for introducing oil under pressure into the pin-receiving hole for effecting movement of the pin in its protruding direction.

The tensioner according to the invention suppresses the flapping noise of a timing chain on engine start-up by permitting forward movement of the plunger but blocking backlash by engagement of the pawl with the rack teeth on the plunger. The prevention of backlash is possible because the pawl-biasing spring acts on the pawl even when air has entered the high-pressure oil chamber after the engine has not been operated for a long time.

On the other hand, the pin-receiving hole becomes filled with oil after the engine is started. Immediately after the pin-receiving hole fills with oil, the pressure exerted by the oil releases the engagement of the pawl with the rack teeth, and permits smooth and rapid protruding and retracting movements of the plunger. That is, when the torque exerted on the pawl by the pressure of the oil in the pin-receiving hole exceeds the opposing torque exerted by the pawl-biasing spring, the pawl is released from the rack teeth and no longer blocks retraction of the plunger.

It is also possible to adjust the timing of disengagement of the pawl from the rack teeth by adjusting the biasing force exerted by the pawl-biasing spring.

In one embodiment of the invention, the second oil supply passage is independent of the first oil supply passage, so that the oil pressures in the first and second passages can be different. When the second oil supply passage is independent of the first oil passage instead of being a branch of the first oil supply passage, it is possible to prevent the pin from being influenced directly by pulsations in the pressure of the oil introduced into the first oil supply passage, even if the capacity of the pin-receiving hole is smaller than that of the high-pressure oil chamber.

Even when the second oil supply passage is independent of the first oil supply passage, when the pin-receiving hole is filled with oil immediately after start-up of the engine, it is possible to release the engagement of the pawl with the rack teeth rapidly, so that smooth and rapid protruding and retracting movements of the plunger can take place.

According to another aspect of the invention, the second oil supply passage can formed in the housing in order to introduce oil under pressure from a source external to said housing directly into the pin-receiving hole. The second oil supply passage formed in the housing passage may be disposed at any desired position irrespective of the location of the first oil supply passage. Accordingly, the length of the second oil passage can be made short, and the passage can be fabricated easily.

In another embodiment, the second oil supply passage is formed in the housing in such a way as to deliver oil from the high-pressure oil chamber directly into the pin-receiving hole. In this embodiment, the pin operates the pawl in synchronism with pulsations in the pressure of the oil in the high pressure oil chamber. Accordingly, the pawl is immediately disengaged from the rack teeth on the plunger on start-up of the engine, permitting smooth protruding and retracting movement of the plunger.

In still another embodiment, the second oil supply passage is provided with an orifice for absorbing pulsation in oil supplied to the pin-receiving hole through the second oil supply passage. The orifice controls the amount of oil introduced into the pin-receiving hole when the supply of oil is excessive. The orifice also controls leakage of oil from the pin-receiving hole when the supply of oil is insufficient. Accordingly, the orifice enables the tensioner to absorb pulsations generated in oil supplied by an oil pump, and also ensures a stable supply of oil to the pin-receiving hole.

According to another aspect of the invention, a pin-supporting spring can be provided in the pin-receiving hole for exerting a force urging the pin in its protruding direction. The pin supporting spring resiliently supports the spring, prevents excessive biting of the pawl into the rack teeth on the plunger, and reducing skipping of the pawl over the rack teeth. Thus, with the pin-supporting spring, it becomes possible for the pawl to engage the rack teeth steadily, blocking skip and excessive biting that would otherwise occur due to the biasing force of the pawl-biasing spring when the engine is started, and permitting protruding displacement of the plunger while blocking the retraction of the plunger.

In embodiments having a pin-supporting spring, the pawl biasing spring exerts a torque on the pawl greater than, and opposed to, the torque exerted on the pawl by the force exerted on the pin by the pin-supporting spring. The pawl is thereby forcibly engaged with the rack teeth on the plunger on engine start-up even when the pin-receiving hole is not fully filled with oil, which can occur especially if the engine in not operated for a long period of time. Accordingly, the tensioner can reliably allow protruding displacement of the plunger while blocking retracting displacement.

In accordance with still another aspect of the invention, the pawl can have a single rack-engaging tooth, whereby the pawl can be is engaged with the rack only at a single location between two adjacent teeth of the rack. The single tooth will not bite excessively into the rack teeth on the plunger, and the ratchet can disengage smoothly from the rack immediately after the time when the engine is started after being inoperative for a long period of time, quickly allowing the plunger to move in its protruding and retracting directions.

### BRIEF DESCRIPTION OF DRAWINGS

FIG. 1 is a schematic view showing a ratchet-type tensioner according to a first embodiment of the invention in cooperation with a pivoted chain guide and a timing chain in a dual overhead cam internal combustion engine;

FIG. 2 is a sectional view of the ratchet-type tensioner shown in FIG. 1;

FIG. 3 is a side view of the ratchet-type tensioner shown in FIG. 1;

FIG. 4 is a sectional view of a portion of the tensioner of FIG. 1, showing the ratchet pawl in engagement with rack teeth on the plunger;

FIG. 5 is a sectional view of a portion of the tensioner of FIG. 1, showing the ratchet pawl disengaged from the rack teeth on the plunger so that the plunger is released;

FIG. 6 is a sectional view of the ratchet-type tensioner according to a second embodiment of the invention;

FIG. 7 is a sectional view of the ratchet-type tensioner according to a third embodiment of the invention;

FIG. 8 is a sectional view of the ratchet-type tensioner according to a fourth embodiment of the invention; and

FIG. 9 is a section view of a prior art ratchet-type tensioner.

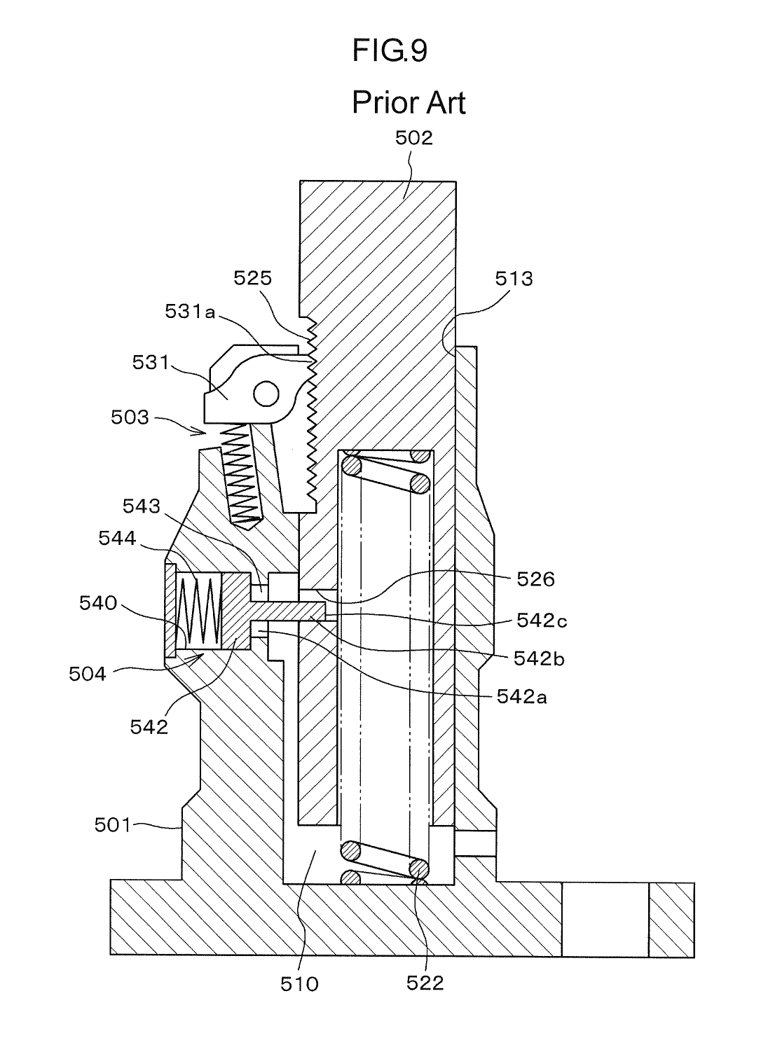

### DETAILED DESCRIPTION OF THE PREFERRED EMBODIMENTS

The invention is applicable to any of a wide variety of ratchet-type hydraulic tensioners having a rocking ratchet pawl mounted on a forward region of the tensioner housing and engageable with a rack of teeth formed on a tensioner plunger in order to permit forward movement of the plunger while blocking backward movement. The tensioner of the invention utilizes a pawl-biasing spring for biasing the ratchet pawl in a direction so that it bites into the rack teeth formed on the plunger, and a hydraulic pin that responds to oil pressure to urge the pawl in a direction such that it releases the engagement of the pawl with the rack teeth.

The oil passage in the tensioner through which oil is delivered to the high pressure oil chamber can receive oil directly from the engine oil pump. Alternatively, an oil reservoir can be formed in the tensioner housing so that oil flowing from the oil pump to the high pressure oil chamber passes through the reservoir.

The tensioner according to the invention also has a check valve for permitting flow of oil into the high pressure oil chamber while blocking reverse flow of oil.

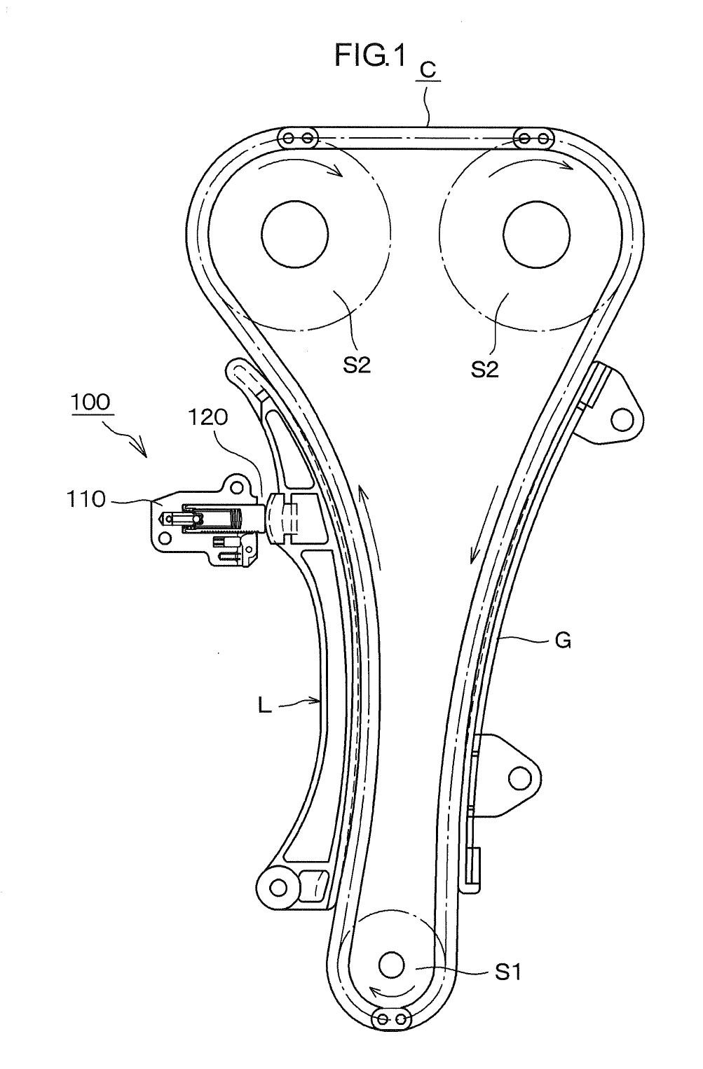

As shown in FIG. 1, a ratchet-type tensioner 100 according to a first embodiment of the invention is attached to an engine body adjacent the slack side of a timing chain C, i.e. the span of the chain that travels from a driving sprocket S1 on the engine crankshaft toward one of two driven sprockets S2 on the engine camshafts. A plunger 120, protruding from the tensioner housing 110 moves in and out of the housing to apply tension to the slack side of the timing chain C through a pivoted lever L by pressing the back of the lever at a location spaced from lever's pivot axis.

The tension side of the chain, i.e., the span traveling toward the crankshaft sprocket S1 from a camshaft sprocket S2, slides on, and is guided by, a stationary chain guide G fixed on the engine body. Arrows in FIG. 1 show the direction of rotation of the sprockets and the direction of movement of the chain.

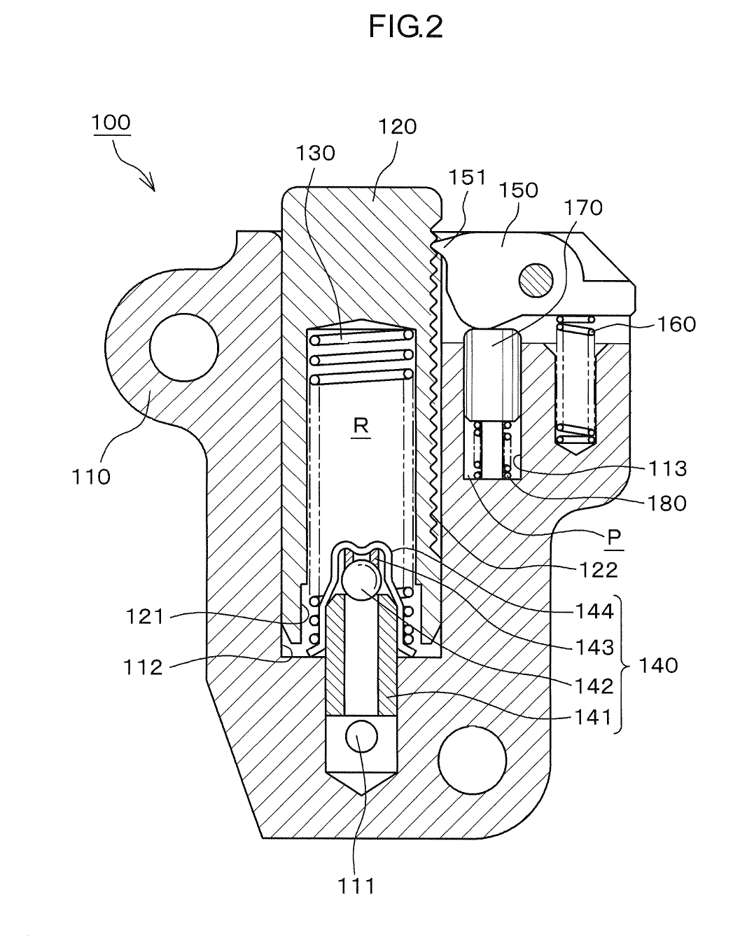

As shown in FIG. 2, a first oil supply passage 111 is provided in the tensioner housing for introducing oil supplied under pressure through the engine block into the high pressure oil chamber R through a check valve unit 140. A plunger 120, which is generally cylindrical in shape except for the fact that a set of rack teeth is formed on its exterior, is slidable in a plunger-accommodating hole 112 in the housing and protrudes from an end opening of the hole 112 toward the chain as shown in FIG. 1. A plunger-biasing spring 130 located within the high-pressure oil chamber R, which is formed by the plunger-accommodating hole 112 and the hollow interior 121 of the plunger 120, urges the plunger in protruding direction. The check valve unit 140, at the bottom of the plunger-accommodating hole 112, i.e., at the end remote from the opening through which the plunger protrudes, allows oil from supply passage 111 to flow into the high pressure oil chamber R while blocking reverse flow. A ratchet pawl 150 is mounted near the front part of the housing 110 for rocking motion on a mounting pin so that, in a rocking motion of the pawl 150, its tooth 151 can engage with, and disengage from rack teeth 122 formed on the side of the plunger. The relative positions of the tooth 151 and the axis on which the pawl is rockable are such that the pawl tooth can disengage from the rack teeth as the pawl rocks clockwise in FIG. 2 while the plunger moves in its protruding direction. However, the pawl cannot rotate sufficiently in the counterclockwise direction to disengage the rack teeth as the plunger moves in the retracting direction. Consequently, the pawl can permit forward displacement of the plunger 120, but block backward displacement of the plunger unless the pawl is rotated clockwise sufficiently that its tooth 151 completely clears the rack teeth, allowing the plunger to move freely in the protruding and retracting directions under the influence of the forces exerted by the oil in chamber R, the plunger-biasing spring 130, and the timing chain without restriction by the ratchet mechanism. A pawl-biasing spring 160 urges the pawl 150 counterclockwise so that it bites into the rack teeth 122. However, as will be seen from the following description, the force exerted by the spring 160 is opposed by a force exerted by a hydraulically operated pin so that the pawl tooth 151 can clear the rack teeth.

The check valve unit 140 is preferably located at or adjacent the bottom of the plunger-accommodating hole 112. Any of various kinds of check valve units can be used to supply oil to chamber R and block reverse flow of oil. Check valve unit 140 comprises a ball seat 141 having an oil passage connected to the first oil supply passage 111 in the housing 110. A check ball 142 is shown seated on an end of ball seat 141. A ball biasing spring 143 presses the check ball 142 against the ball seat 141, and a bell-shaped retainer 144 supports the ball biasing spring 143 and restricts displacement of the check ball 142.

The housing 110 is also provided with a cylindrical hole 113 adjacent the plunger-accommodating hole 112. A pin 170 is slidable in hole 113, and protrudes outward from 113, pressing against a part of pawl 150 on the side of the pawl-mounting pin opposite from the side at which spring 160 is located. An oil chamber P is formed by the pin-receiving hole 113 and the hydraulic pin 170. A pin-supporting spring 180 located within hole 113 engages the inner end of pin 170, and supports the pin, preventing the pawl from rotating so far counterclockwise that the pawl tooth 151 can skip over the rack teeth 122, and also preventing the pawl tooth from biting into the rack teeth 122 with excessive force.

The pin-supporting spring 180 is disposed so that it exerts a resilient force on the pawl 150 when pawl tooth 151 bites into the rack teeth 122. However, when hydraulic pressure within hole 113 causes the pawl tooth 151 to disengage from the rack teeth the spring 180 becomes disengaged from the pin 170 and does not exert a force on the pin. As will be apparent from FIG. 2, the spring 160 exerts a torque on the pawl 150 tending to rotate the pawl counterclockwise, while pin 170 exerts an opposing torque on the pawl tending to rotate the pawl clockwise.

The pin-supporting spring 180 prevents tooth skip and excessive biting that could otherwise occur due to the biasing force exerted by pawl biasing spring 160 when the engine is started. On engine start-up, the plunger 120 is permitted to move forward, but is blocked from moving backward so that flapping sounds of the timing chain are suppressed. After engine start-up, the oil pressure in the pin-receiving hole pushes pin 170 outward, releasing the engagement of pawl 150 from the rack teeth 122.

The timing of release of the engagement of the pawl 150 with the rack teeth 122 can be adjusted by selection of a pawl-biasing spring 160 that exerts an appropriate force in relation to the resilient force exerted by the pin-supporting spring 180. The resilient force of the pin-supporting spring 180 should be related to the force of the pawl-biasing spring 160 so that the net torque on the pawl 150 resulting from both forces is counterclockwise in FIG. 2, i.e., in a direction such that the pawl tooth 151 is pressed against the rack teeth. Thus, the pawl biasing spring 160 forcibly engages the pawl 150 with the rack teeth 122 on engine start-up at least when the engine has not been operated for a long time and chamber P is not filled with oil. This arrangement permits protruding displacement of the plunger 120 while blocking retraction thereof on engine start-up, thereby suppressing flapping sounds generated by the timing chain.

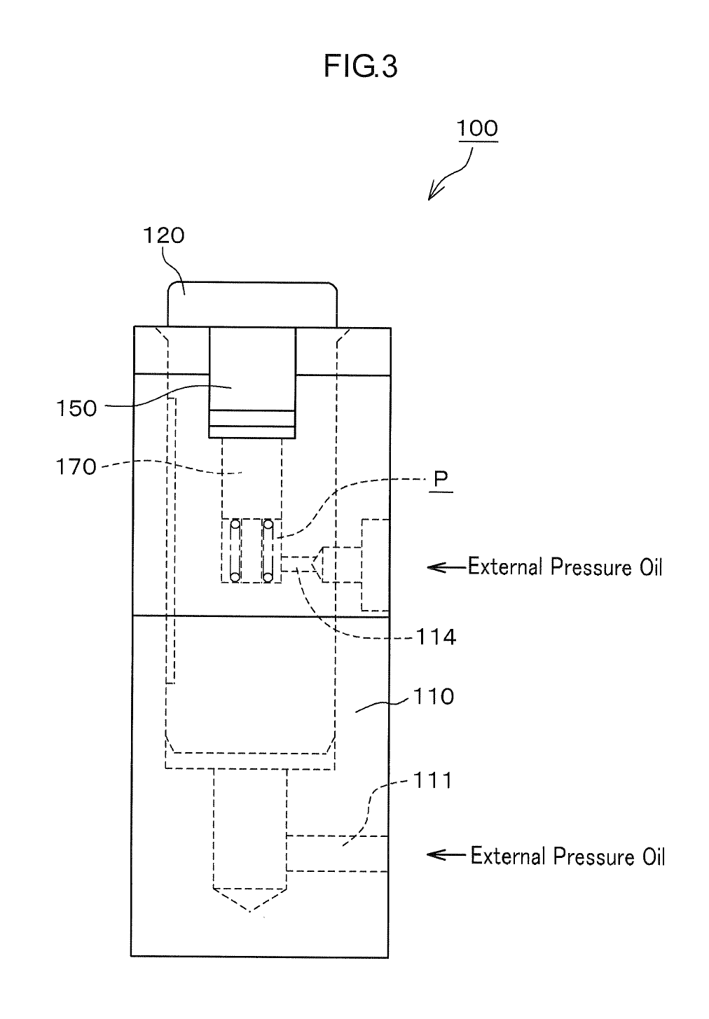

As shown in FIG. 3, a second oil supply passage 114 in the housing is provided for introduction of oil into the oil chamber P of the pin-receiving hole 113. When oil is introduced into the chamber P, the pin 170 moves outward, pressing the pawl 150 in a direction (counterclockwise in FIG. 2) such that the engagement of the pawl tooth 151 with the rack teeth 122 is released.

Since the pawl 150 has only a single tooth 151 for engagement with the rack teeth 122, the pawl engages the rack teeth only at one point. As a result, the pawl 150 does not bite excessively into the rack teeth 122, and disengages smoothly from the rack teeth when the engine is started after being inoperative for a long period of time. The engagement of pawl 150 with the rack teeth 122 is released instantly, and the plunger 120 is quickly brought to a condition in which it has complete freedom to move forward and backward under the influence of the forces exerted by the plunger-biasing spring, the oil in the high pressure oil chamber, and the timing chain.

Although a pawl having a single tooth for engagement with the plunger rack teeth at only one point is preferred, a pawl having multiple teeth can be used provided that its engagement with the rack teeth can be released quickly so that forward and backward movement of the plunger can commence quickly after engine start-up.

As shown in FIG. 3, the second oil supply passage 114 in the housing 110 is independent of the first oil supply passage 111. That is, passage 114 is not a branch of passage 111, nor are both passages formed as branches of another passage within the tensioner housing. Instead, passage 114 is formed so that it can introduce oil supplied from a passage in an engine block directly into the oil chamber P within pin-receiving hole 113. In this embodiment it is possible for the operation of the pin 170 to avoid being directly influenced by pulsations in the external oil introduced under pressure into the first oil supply passage 111 even though the capacity of chamber P in the pin-receiving hole 113 is smaller than that of the high-pressure oil chamber R into which the oil is introduced from the first oil supply passage 111. By making the oil supply passages independent of each other, it is possible to avoid the influence of pulsations, and thereby ensure stably generation of hydraulic pressure within chamber P in the pin-receiving hole 113 so that the chamber P can rapidly fill with oil and forward and backward movement of the plunger 120 can commence quickly following engine start-up.

An additional advantage to the embodiment in which the oil supply passages are independent is that the second oil supply passage 114 can be made short, and disposed at a position in which it can be formed easily and inexpensively by drilling or by other suitable means.

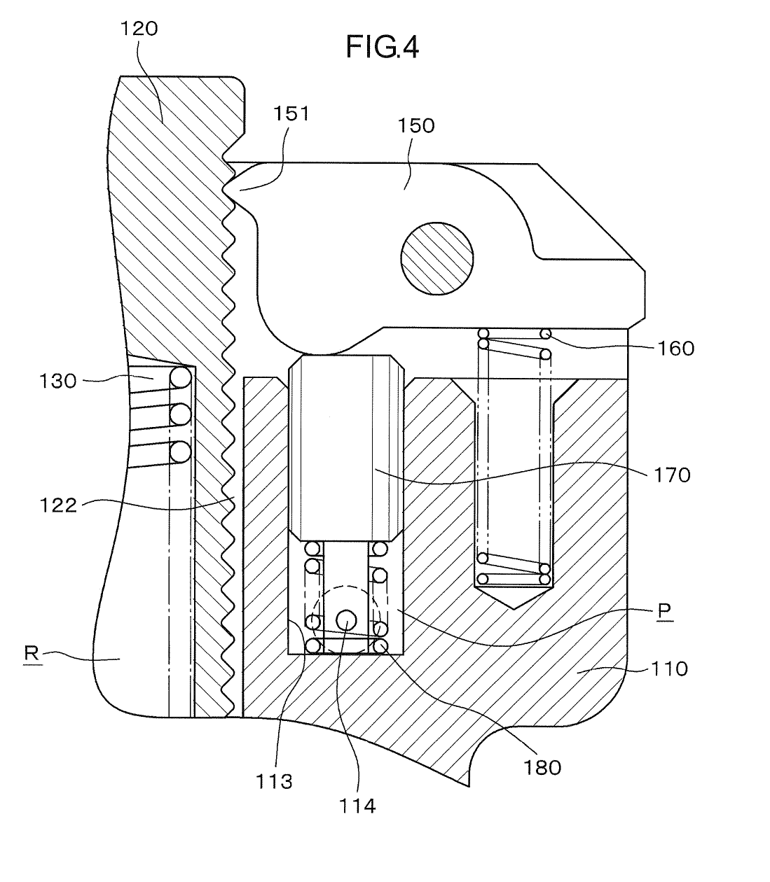

In the operation of the ratchet-type tensioner 100, at first, no oil under pressure is supplied from the engine block to the second oil supply passage 114. The torque exerted on the pawl by the hydraulic pressure in chamber P of the pin-receiving hole is smaller than the torque exerted on the pawl by the pawl-biasing spring 160 when the engine is stopped and upon starting of the engine. Consequently, as shown in FIG. 4, the tensioner is initially in a condition in which the pawl tooth 151 is engaged with the rack teeth 122 by the biasing force of the pawl-biasing spring 160, and blocks retraction of the plunger 120 due to forces received from the timing chain.

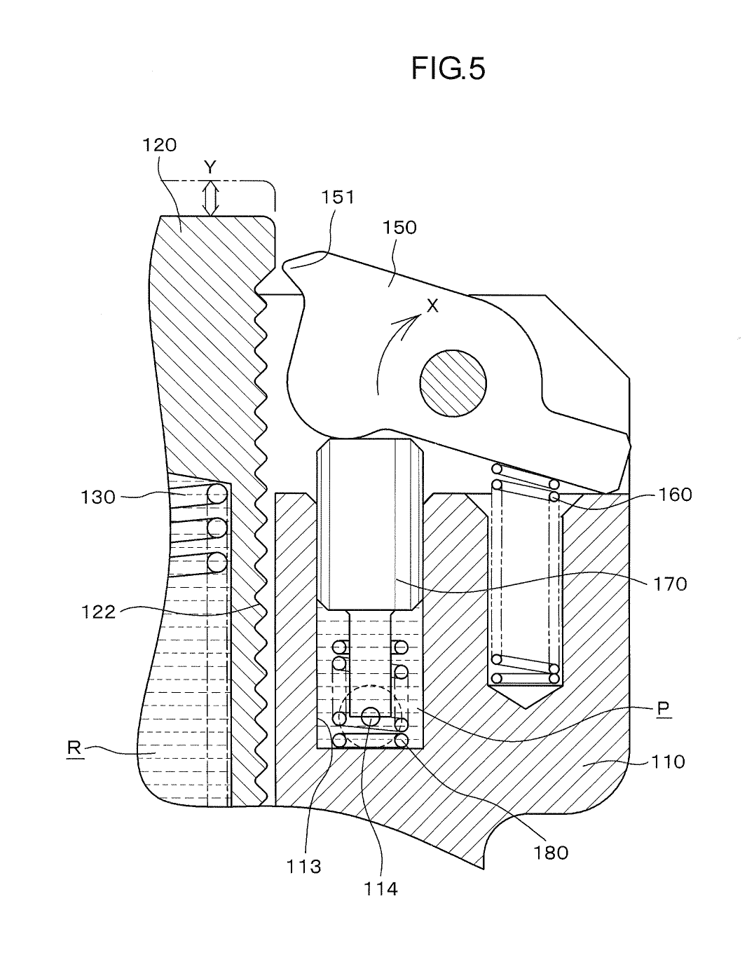

However, immediately after starting the engine, oil is supplied under pressure from the engine block through the second oil supply passage 114, and the pressure of the oil in chamber P of the pin-receiving hole rotates the pawl 150 in the direction of arrow X in FIG. 5 against the biasing force of the pawl biasing spring 160, releasing its tooth 151 from the rack teeth 122 without skip. The hydraulic pressure, which is stably generated within chamber P of the pin-receiving hole thus rotates the pawl out of engagement with the rack, permitting smooth forward and backward movement of the plunger 120 along the direction Y as shown in FIG. 5.

The tensioner 100 of the first embodiment suppresses flapping noise of the timing chain by permitting forward displacement, while blocking backward displacement of the plunger 120 causing backlash, by allowing the pawl 150 to remain engaged with the rack teeth 122 for a short time following engine start-up. In effect, engagement of the pawl with the rack of teeth on the plunger, resulting from the action of the pawl-biasing spring 160, compensates for insufficient hydraulic pressure within the high-pressure oil chamber R resulting from the presence of air that enters the high-pressure oil chamber R after the engine has been inoperative for a long period of time. Moreover, since the second oil supply passage 114 is independent of the first oil supply passage 111, it is possible to avoid having pulsations in the pressure of the oil introduced into the first oil supply passage influence the pressure in chamber P of the pin-receiving hole. When the chamber P of the pin-receiving hole fills with oil after engine start-up, the oil pushes pin 170 outward, instantly and smoothly releasing the pawl 150 from the rack teeth 122, thereby permitting smooth forward and backward movements of the plunger 120.

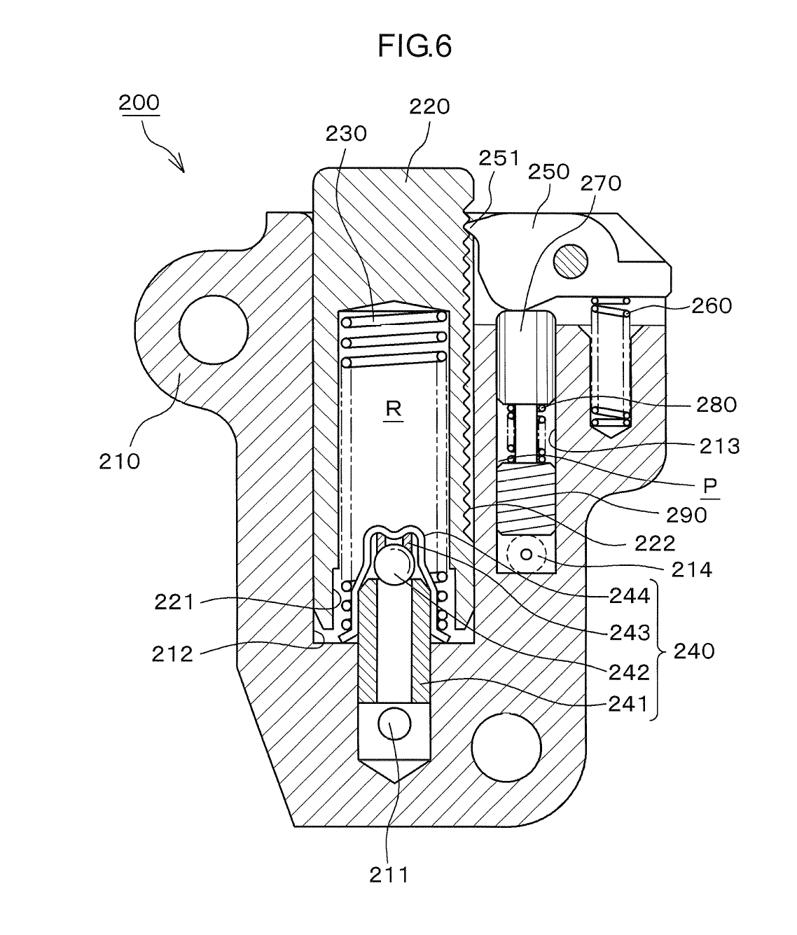

A second embodiment of the ratchet-type tensioner is tensioner 200, shown in FIG. 6. This tensioner is used in the same manner as the ratchet-type tensioner 100 described above, but is different in that it is provided with an orifice 290 for absorbing pulsations in the oil supplied under pressure from the engine block. Except for the orifice and the extension of the length of the pin-receiving hole in order to accommodate the orifice, the structure is substantially the same as that of the tensioner 100 described above. Accordingly, parts of the ratchet-type tensioner 200 shown in FIG. 6 that are identical with, or correspond to, those of the ratchet-type tensioner 100 are denoted by reference numerals exceeding by 100, the corresponding reference numerals in FIG. 2.

The orifice 290 controls the amount of the oil under pressure introduced into chamber P of the pin-receiving hole through the second oil supply passage 214, when the amount of supplied oil is excessive. The orifice 290 also controls leakage of oil from chamber P of the pin-receiving hole when the oil supply through passage 214 is insufficient.

The ratchet-type tensioner 200 exhibits all of the advantageous effects of the first embodiment. In addition, because the second oil supply passage 214 is provided with an orifice 290 that absorbs pulsations in the oil, controls the amount of oil introduced into the chamber P when the oil supply is excessive, and also suppresses leakage of the oil from chamber P when the oil supply is insufficient, the tensioner absorbs pulsations that generated by the oil pump, and can assure a stable supply of oil under pressure to the chamber P in pin-receiving hole.

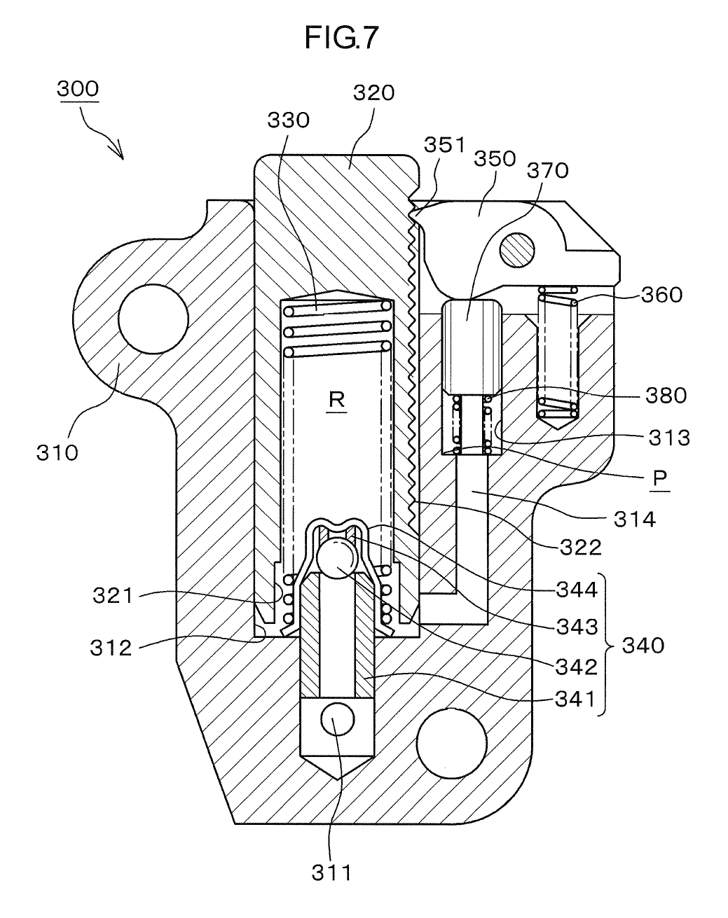

A third embodiment of the ratchet-type tensioner is tensioner 300, shown in FIG. 7. This tensioner is used in the same manner as the ratchet-type tensioner 100 described above, but is different in the disposition and configuration of the second oil supply passage 314 for introducing oil into the chamber P of the pin-receiving hole. In other respects, the structure of tensioner 300 is the same with that of tensioner 100 described above. Accordingly, parts of the ratchet-type tensioner 300 shown in FIG. 7 that are identical with, or correspond to, those of the ratchet-type tensioner 100 are denoted by reference numerals exceeding by 200, the corresponding reference numerals in FIG. 2.

The second oil supply passage 314, for introducing oil into the oil chamber P of pin-receiving hole 312, is formed in the housing 310 and communicates directly with the high pressure oil chamber R at a location near the bottom of the plunger-accommodating hole 312. The passage 314 is connected to high pressure oil chamber R on the downstream side of check valve unit 340, and is therefore not a branch of oil supply passage 311, but independent thereof.

If the hydraulic pressure within chamber P of the pin-receiving hole receives pulsations from the high-pressure oil chamber R, the hydraulic pin 370 acts in synchronism with these pulsations, so that the tensioner 300 releases the engagement of the pawl tooth 351 from the rack teeth 322 immediately in correspondence with to the forward movement of the plunger 320 after start-up of the engine, permitting smooth forward and backward movement of the plunger 320.

The ratchet-type tensioner 300 exhibits the advantageous effects of the first embodiment. In addition, because the second oil supply passage 314 introduces oil from the high-pressure oil chamber R directly into the chamber P in the pin-receiving hole tensioner 300 releases engagement of the pawl tooth 351 from the rack teeth 322 immediately upon forward movement of the plunger 320 following engine start-up, when the chamber P fills with oil in synchronism with the pulsations in the high-pressure oil chamber R. Release of the engagement of the pawl with the plunger rack permits forward and backward movements of the plunger 320 to commence smoothly and quickly. Here as in the previously described embodiments timing of disengagement of the pawl from the rack teeth can be adjusted by replacing the pawl biasing spring 360.

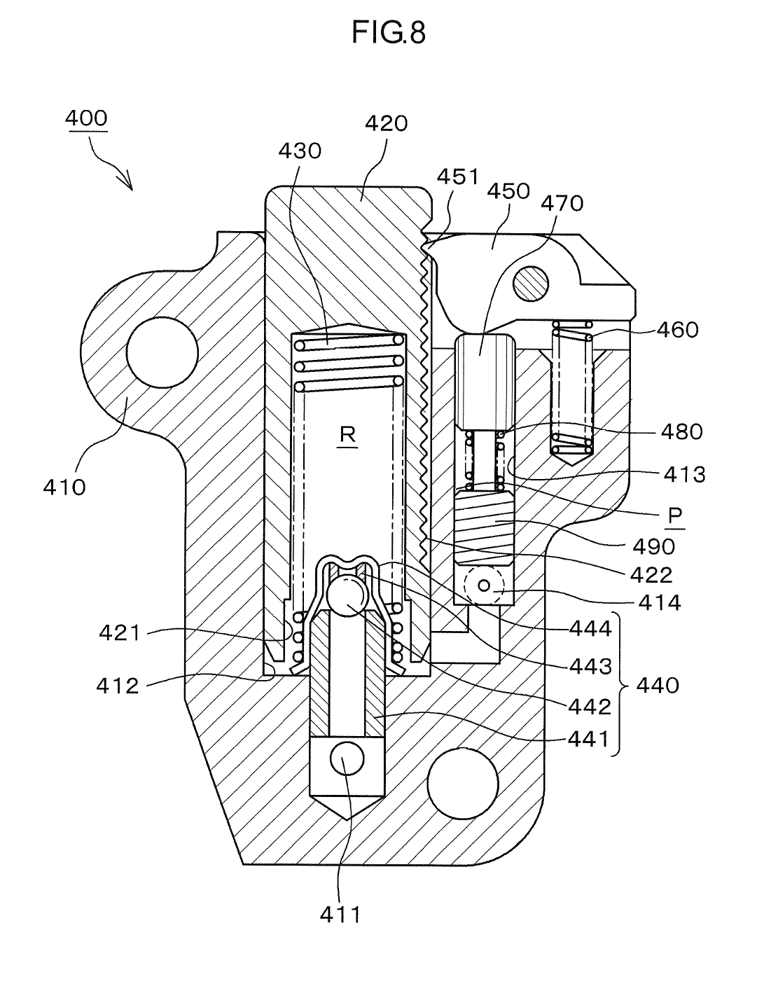

A fourth embodiment of the ratchet-type tensioner is tensioner 400, shown in FIG. 8. This tensioner is used in the same manner as the ratchet-type tensioners 300 described above, but is different in that an orifice 490 is provided in the second oil supply passage 414 to absorb pulsations in the oil. In other respects, the structure of tensioner 300 is the same with that of tensioner 100 described above. Accordingly, parts of the ratchet-type tensioner 400 shown in FIG. 8 that are identical with, or correspond to, those of the ratchet-type tensioner 300 are denoted by reference numerals exceeding by 100, the corresponding reference numerals in FIG. 7.

The ratchet-type tensioner 400 exhibits the advantages of tensioner 300, and, because the second oil supply passage 414 is provided with an orifice 490 that absorbs pulsation in the oil, controls the amount of oil introduced into the chamber P when the oil supply in passage 414 is excessive, and also suppresses leakage of oil that has been introduced into the chamber P when the oil introduced into chamber P is insufficient, the tensioner 400 absorbs pulsations generated in the oil pump and can assure a stable supply of oil under pressure to the oil chamber P in the pin-receiving hole 413.

What is claimed is:

1. A ratchet-type tensioner, comprising:
a housing having a first oil supply passage for introducing oil under pressure into the housing;
a plunger-accommodating hole in the housing, said hole having an opening;
a plunger slidable in said plunger-accommodating hole and protruding in a projecting direction outward from said opening for applying tension to a traveling chain, the plunger having a hollow interior, said hollow interior and the plunger-accommodating hole cooperatively forming a high-pressure oil chamber that expands with sliding movement of the plunger in said projecting direction and contracts with sliding movement of the plunger in a direction opposite to said projecting direction, said plunger also having a longitudinally extending rack comprising a set of rack teeth formed on its exterior;
a plunger-biasing spring in said high-pressure oil chamber, biasing the plunger in the projecting direction;
a check valve located at an end of said plunger-accommodating hole opposite from said opening the check valve being arranged to deliver oil from said oil supply passage into the high pressure oil chamber and to block reverse flow of oil from the high-pressure oil chamber to the oil supply passage;
a ratchet pawl rockably supported on the housing for rotation about a pawl axis, the pawl having a pawl tooth engageable with, and disengageable from, the rack on the plunger, the pawl blocking retracting movement of the plunger when engaged with said rack;
a pawl-biasing spring for urging said pawl to rotate in a direction about the pawl axis such that its pawl tooth comes into engagement with said rack;
a pin-receiving hole formed in the housing;
a pin slidable in said pin-receiving hole and protruding therefrom, the pin being in engagement with the pawl and arranged to rotate the pawl about its pawl axis in a direction such that the pawl tooth disengages from the rack when the pin moves in a protruding direction; and
a second oil supply passage for introducing oil under pressure into said pin-receiving hole for effecting movement of said pin in its protruding direction.

2. A ratchet-type tensioner according to claim 1, in which said second oil supply passage is independent of said first oil supply passage, whereby the oil pressures in said first and second passages can be different.

3. A ratchet-type tensioner according to claim 1, wherein said second oil supply passage is formed in said housing so as to introduce oil from a source external to said housing directly into said pin-receiving hole.

4. A ratchet-type tensioner according to claim 1, wherein said second oil supply passage is formed in said housing so as to deliver oil from said high-pressure oil chamber directly into said pin-receiving hole.

5. A ratchet-type tensioner according claim 1, wherein said second oil supply passage is provided with an orifice for absorbing pulsation in oil supplied to the pin-receiving hole through the second oil supply passage.

6. A ratchet-type tensioner according to claim 1, wherein a pin-supporting spring is provided in said pin-receiving hole for exerting a force urging the pin in its protruding direction.

7. A ratchet-type tensioner according to claim 6, wherein the pawl biasing spring exerts a torque on the pawl greater than, and opposed to, the torque exerted on the pawl by the force exerted on the pin by the pin-supporting spring.

8. A ratchet-type tensioner according to claim 1, wherein said pawl has a single rack-engaging tooth, whereby the pawl can be is engaged with the rack only at a single location between two adjacent teeth of the rack.
